(19) United States
(12) Patent Application Publication
(10) Pub. No.: US 2023/0029553 A1
(43) Pub. Date: Feb. 2, 2023

(54) FASTENING SCREW AND HEIGHT-ADJUSTABLE TABLE USING THE SAME

(71) Applicant: ZHEJIANG INTIAN HEALTH TECHNOLOGY CO.,LTD., Ningbo (CN)

(72) Inventors: Peng WANG, Ningbo (CN); BiSheng ZHENG, Ningbo (CN)

(73) Assignee: ZHEJIANG INTIAN HEALTH TECHNOLOGY CO.,LTD., Ningbo (CN)

(21) Appl. No.: 17/586,825

(22) Filed: Jan. 28, 2022

(30) Foreign Application Priority Data
Jul. 29, 2021 (CN) 202121755988.4

(51) Int. Cl. F16B 23/00

(52) U.S. Cl. CPC F16B 23/0069; F16B 23/0038; F16B 2200/00

(57) ABSTRACT

A fastening screw and a height-adjustable table using the same are provided. A threadless transition portion is provided between a threaded section and a head portion of the fastening screw to increase the contact area between the screw and a workpiece, and to cooperate with a shaft portion to fasten the workpiece. The transition portion is provided with a tapered wall surface, and the transition portion expands from the threaded section to the head portion of the screw. The screw offers a tension expanding outward in a circumferential direction of a mounting portion. An area of a joint between the transition portion and the head portion does not exceed a circumferential area of threads. In a direction of a central axis of the screw, the projection of the transition portion overlaps that of the shaft portion, which prevents the transition portion from falling off the workpiece or damaging the workpiece.

### CROSS REFERENCE TO THE RELATED APPLICATIONS

This application is based upon and claims priority to Chinese Patent Application No. 202121755988.4, filed on Jul. 29, 2021, the entire contents of which are incorporated herein by reference.

### TECHNICAL FIELD

The present invention relates to the field of screws, and more particularly, to a fastening screw and a height-adjustable table using the same.

### BACKGROUND

As a common fastener, screws are widely used in machinery, electrical appliances and buildings. Screws are typically made of metal or plastic, cylindrical in shape, and threaded on the surface. The fastening screws are easy to fall off due to vibration during use or disassembly, causing the screws to be lost or interfering with the operation of other parts.

At present, screws are mainly used with washers to fasten workpieces. The washers increase the contact area of the screws, reduce the pressure, and protect the parts and the screws. Most of the commonly used screws on the market are standard screws, which do not have the functions of anti-loosening and protecting the base. Therefore, in order to prevent the screws from loosening, it is usually necessary to adopt elastic washers or flat washers adapted to the screws. However, the washers are prone to wear with the base during use. During assembly, because the washer and the screw are separated, the washer needs to be sleeved on the connecting portion of the screw, which increases the workload of assembly and easily causes the washer to slip off.

In the prior art, there are some technical solutions of fastening screws using washers. For example, the Chinese patent CN204113857U discloses a screw with a washer. The screw includes a head portion and a connecting portion connected to the head portion. The connecting portion is provided with threads. A transition portion is provided between the head portion and the threads of the connecting portion, and the transition portion has a diameter less than that of the threads. A plastic washer is sleeved on the transition portion. The inner ring of the plastic washer is polygonal, and the inner ring of the plastic washer has an inscribed circle with a diameter less than that of the threads. This technical solution solves the problems of inconvenient mounting and easy slip of the split washer-screw structure. In addition, since the material of the washer is replaced from the traditional metal to the plastic, it reduces the wear on the base. However, the screw is prone to damage the through hole when it is tightened, and the plastic washer has a short service life and poor fastening performance.

For example, the Chinese patent CN1910373A discloses a screw. The screw includes a screw body, a torque transmission mechanism, and a bonding and curing layer. The screw body is provided with a male threaded portion formed to be screwed and fastened into a corresponding threaded hole and a crest portion formed integrally with one end of the male threaded portion and provided with a top end surface. The torque transmission mechanism is used to transmit a rotation torque to the crest portion, where the rotation torque is required to screw and fasten the male threaded portion into the threaded hole, and the torque transmission mechanism is provided with a base end surface morphologically corresponding to the top end surface of the crest portion. The bonding and curing layer is used to bond the top end surface of the crest portion and the base end surface of the torque transmission mechanism, so as to mechanically connect the crest portion and the torque transmission mechanism. This technical solution forms a cured layer with an adhesive, and peels off the cured layer by heat treatment using warm water, etc., so as to make the screw reusable. However, in actual use, the fastening performance of the screw is easily affected by the ambient temperature, and the operation method of the screw is complicated and still has some shortcomings.

In short, the fastening screws in the prior art have problems such as poor fastening and anti-slip performance, complicated split washer-screw structure, inconvenient mounting and low tension.

### SUMMARY

The present invention provides a fastening screw and a height-adjustable table using the same. The fastening screw has the advantages of desirable fastening and anti-falling performance, simple structure and easy mounting. The present invention solves the problems of the fastening screw in the prior art, such as poor fastening and anti-falling performance, complicated split washer-screw structure, inconvenient mounting and poor tension.

A concept of the present invention is to provide a fastening screw and a height-adjustable table using the same. The screw is provided with a transition portion, which improves the fastening performance of the screw and prevents the screw from falling off a workpiece.

Further, in another concept of the present invention, the transition portion is provided between a threaded shaft portion and a head portion of the screw. After fastening a workpiece, the transition portion is fully tightly fit with the workpiece, which increases the friction between the screw and the workpiece and reduces the possibility of loosening.

Further, in another concept of the present invention, the transition portion is shaped like a circular truncated cone, and the transition portion expands from a joint between the transition portion and the threaded shaft portion to the head portion of the screw. By adopting such a transition portion, when the screw is used to mount a workpiece, the circular truncated cone-shaped transition portion is tightly fit with the workpiece to generate a radial stress to fasten the workpiece with the screw. In this way, the screw is not easy to loosen, and its fastening effect on the workpiece is improved.

Further, in another concept of the present invention, a maximum radius of the transition portion does not exceed a radius of a threaded section. In this way, the transition portion can smoothly enter the workpiece while preventing the workpiece from undergoing large deformation.

Further, in another concept of the present invention, a height-adjustable table is provided, which uses the above-mentioned fastening screw, thereby greatly prolonging the service life of the height-adjustable table and improving the stability performance thereof.

The present invention provides a fastening screw and a height-adjustable table. The fastening screw is mainly used to fasten a workpiece.

Specifically, the present invention provides a fastening screw. The fastening screw includes a head portion and a shaft portion, where the head portion is connected to the shaft portion; and
a transition portion is provided between the head portion and the shaft portion, and the transition portion is tightly fit with a workpiece to be fastened.

Further, the transition portion is threadless.

A traditional screw is evenly provided with threads on a shaft portion. In contrast, in the present invention, the threadless transition portion is provided between the shaft portion and the head portion of the screw. The transition portion will be in stable pressing contact with the workpiece as the screw enters a hole of the workpiece, thereby increasing a contact area between the screw and the workpiece, and cooperating with the shaft portion to further fasten the workpiece. This design greatly improves the friction between the screw and the workpiece, and improves the fastening effect of the screw on the workpiece.

In some embodiments, the transition portion is provided with a circular truncated cone-shaped wall surface.

Further, the transition portion expands from the shaft portion to the head portion.

Further, an area of a joint between the transition portion and the head portion of the screw is greater than an area of a joint between the transition portion and the shaft portion.

Further, the axial projection of the joint between the transition portion and the head portion of the screw and the axial projection of the joint between the transition portion and the shaft portion are concentric circles.

Further, a circumferential radius of the joint between the transition portion and the head portion of the screw is greater than a circumferential radius of the joint between the transition portion and the shaft portion of the screw.

Further, the circumferential radius of the joint between the transition portion and the head portion of the screw is 0.1-0.2 mm greater than the circumferential radius of the joint between the transition portion and the shaft portion of the screw.

A traditional fastening screw uses a flat washer or a spring washer to increase the friction between the screw and the workpiece and reduce the possibility of screw loosening. In this technical solution, the transition portion is provided with a circular truncated cone-shaped transition surface. The transition surface can increase the contact area between the screw and the workpiece, and increase the friction between the entire screw and the workpiece, such that the screw is not easy to loosen after being tightened. In addition, in this technical solution, the tapered surface of the transition portion expands from the shaft portion to the head portion. In this structure, tension is generated between the inclined wall surface and the mounting portion of the workpiece. When threads cut into the workpiece, a rigid deformation occurs between the tapered expansion surface and the workpiece. The tension is far greater than that generated by a straight cylindrical wall, such that the screw is tight at the mounting portion to fix the workpiece in a radial direction. Therefore, the screw is hard to loosen and slip off.

In some embodiments, the shaft portion is provided with threads, and the screw is engaged with the workpiece through the threads.

In this technical solution, the screw with the threaded shaft portion has desirable fastening and anti-falling performance and a stable structure compared with a screw with a smooth wall surface. When the threads of the shaft portion are connected to the workpiece, the engagement of the threads offers a desirable axial fastening force, which prevents the screw from moving relative to the workpiece.

In some embodiments, the axial projection of a joint between the transition portion and the head portion of the screw and the axial projection of the shaft portion of the screw are concentric circles.

Further, an axial projection area of the joint between the transition portion and the head portion of the screw is not greater than an axial projection area of the threads of the shaft portion of the screw.

In the present invention, the axial projection area of the joint between the transition portion and the head portion of the screw is less than the axial projection area of the threads of the shaft portion of the screw. When the screw is completely tightened, the transition surface mainly acts on an internal thread portion of the workpiece to ensure that the transition portion of the screw tightly presses the workpiece while preventing the main body of the workpiece from deforming.

In some embodiments, an axial length of the transition portion is greater than an axial length of at least two threads of the threaded shaft portion, and is less than an axial length of at most six threads of the threaded shaft portion.

The present invention limits the length of the transition portion. Since the transition portion mainly acts on the free or internal threaded portion of the workpiece, the slope of the tapered surface of the transition portion will affect the contact effect. When the axial length of the transition portion (the height of the circular truncated cone) is greater than the axial length of at least two threads of the threaded shaft portion and less than the axial length of at most six threads of the threaded shaft portion, the screw of the present invention has the best fastening effect.

In some embodiments, the present invention further provides a use of the above-mentioned screw.

In some embodiments, the present invention provides a height-adjustable table using the above-mentioned screw.

The height-adjustable table is provided with a mounting hole for assembly. The fastening screw passes through the mounting hole to cooperate with a nut through threads to connect components of the height-adjustable table.

In the prior art, the screw used by a height-adjustable table is an ordinary screw, which is easy to fall off after long-term use. In view of this, the present invention provides a height-adjustable table using the above-mentioned fastening screw. The fastening screw has a simple structure and is not easy to loosen, which greatly prolongs the service life of the height-adjustable table and improves the stability performance thereof.

The present invention provides a fastening screw and a height-adjustable table using the same. The threadless transition portion is provided between the threaded section and the head portion of the fastening screw to increase the contact area between the screw and the workpiece, and to cooperate with the shaft portion to further fasten the workpiece. The transition portion is provided with a tapered wall surface, and the transition portion expands from the threaded section to the head portion of the screw. Thus, the screw offers a tension expanding outward in a circumferential direction of the mounting portion, thereby improving the tightness. The joint area between the transition portion and the head portion does not exceed a circumferential area of the threads. Therefore, in a direction of a central axis of the screw, projection of the transition portion overlaps that of the shaft portion, which prevents the transition portion from falling off the workpiece or damaging the workpiece. The fastening screw provided by the present invention has the advantages of simple structure, desirable fastening and anti-falling performance and convenient mounting, etc.

### BRIEF DESCRIPTION OF THE DRAWINGS

The present invention will be further described in detail below with reference to the drawings and preferred embodiments. However, those skilled in the art should understand that these drawings are drawn only for the purpose of explaining the preferred embodiments, and therefore should not be construed as a limitation to the scope of the present invention. In addition, unless otherwise specified, the drawings are only intended to conceptually represent the composition or configuration of the described objects and may include exaggerated displays, and the drawings are not necessarily drawn to scale.

FIG. 1 is a structural view of a fastening screw according to the present invention;

FIG. 2 is a lateral view of the fastening screw according to the present invention;

FIG. 3 is a structural view of the fastening screw and a height-adjustable table using the same according to the present invention; and

FIG. 4 is a detail view of A shown in FIG. 1.

Reference Numerals: 1. head portion; 2. shaft portion; 3. transition portion; 4. threads; 5. washer; 6. slot; 7. fastening screw; 8. height-adjustable table; 9. mounting hole; and 10. nut.

### DETAILED DESCRIPTION OF THE EMBODIMENTS

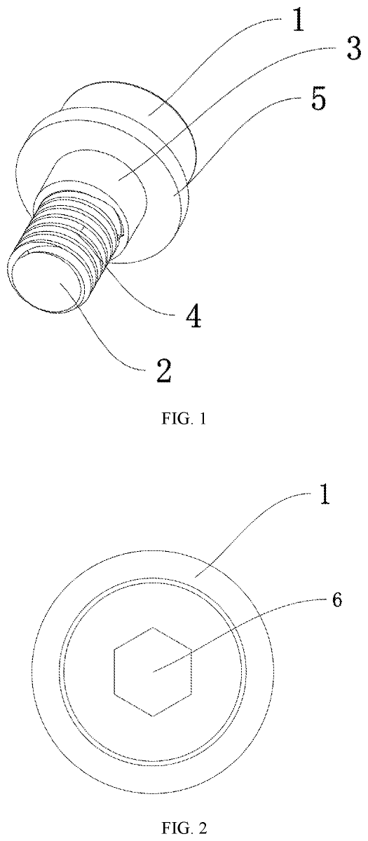

The present invention is described in detail below with reference to FIGS. 1 to 4.

In order to make the objectives, technical solutions and advantages of the present invention clearer, the present invention will be further described in detail below with reference to the drawings and embodiments. It should be understood that the specific embodiments described herein are merely intended to explain the present invention, rather than to limit the present invention.

FIGS. 1 and 2 show a specific embodiment of the present invention.

This embodiment specifically provides a fastening screw, including a head portion 1 and a shaft portion 2. The head portion 1 is connected to the shaft portion 2.

A transition portion 3 is provided between the head portion 1 and the shaft portion 2, and the transition portion 3 is tightly fit with a workpiece to be fastened.

The transition portion 3 is threadless.

The threadless transition portion 3 is provided between the shaft portion 2 and the head portion 1 of the screw. The transition portion 3 will be in stable pressing contact with the workpiece as the screw enters a hole of the workpiece, thereby increasing a contact area between the screw and the workpiece, and cooperating with the shaft portion 2 to further fasten the workpiece. This design greatly improves the friction between the screw and the workpiece, and improves the fastening effect of the screw on the workpiece.

Further, the present invention provides another embodiment, as shown in FIGS. 1 and 2.

In a main concept of this embodiment, the transition portion 3 is provided with a tapered wall surface, and the transition portion 3 expands from a threaded section to the head portion 1 of the screw. In this way, the screw offers a tension expanding outward in a circumferential direction of a mounting portion, thereby improving the tightness.

This embodiment specifically provides a fastening screw, including a head portion 1 and a shaft portion 2. The head portion 1 is connected to the shaft portion 2. A transition portion 3 is provided between the head portion 1 and the shaft portion 2, and the transition portion 3 is tightly fit with a workpiece to be fastened. The transition portion 3 is threadless.

The transition portion 3 is provided with a tapered wall surface, and the transition portion 3 expands from the shaft portion 2 to the head portion 1.

An area of a joint between the transition portion 3 and the head portion 1 of the screw is greater than that of a joint between the transition portion 3 and the shaft portion 2. The axial projection of the joint between the transition portion 3 and the head portion 1 of the screw and the axial projection of the joint between the transition portion 3 and the shaft portion 2 are concentric circles. A circumferential radius of the joint between the transition portion 3 and the head portion 1 of the screw is greater than a circumferential radius of the joint between the transition portion 3 and the shaft portion 2 of the screw. The circumferential radius of the joint between the transition portion 3 and the head portion 1 of the screw is 0.1-0.2 mm greater than the circumferential radius of the joint between the transition portion 3 and the shaft portion 2 of the screw.

A traditional screw uses a flat washer or a spring washer for fastening to increase the friction between the screw and the workpiece and reduce the possibility of screw loosening. In this embodiment, the transition portion 3 is provided with a circular truncated cone-shaped transition surface. The transition surface can increase the contact area between the screw and the workpiece, and increase the friction between the entire screw and the workpiece, such that the screw is not easy to loosen after being tightened. In addition, in this embodiment, the tapered surface of the transition portion 3 expands from the shaft portion to the head portion. In this structure, tension is generated between the inclined wall surface and the mounting portion of the workpiece. When threads cut into the workpiece, a rigid deformation will occur between the tapered expansion surface and the workpiece. The tension is far greater than that generated by a straight cylindrical wall, such that the screw is tight at the mounting portion to fix the workpiece in a radial direction. Therefore, the screw is hard to loosen and slip off.

Further, the present invention provides another embodiment, as shown in FIGS. 1 and 2.

In a main concept of this embodiment, the joint area between the transition portion 3 and the head portion 1 does not exceed a circumferential area of threads 4. In a direction of a central axis of the screw, projection of the transition portion 3 overlaps that of the shaft portion 2, so as to prevent the transition portion 3 from falling off the workpiece or causing damage to the workpiece.

This embodiment specifically provides a fastening screw, including a head portion 1 and a shaft portion 2. The head portion 1 is connected to the shaft portion 2. A transition portion 3 is provided between the head portion 1 and the shaft portion 2, and the transition portion 3 is tightly fit with a workpiece to be fastened. The transition portion 3 is threadless. The transition portion 3 is provided with a tapered wall surface, and the transition portion 3 expands from the shaft portion 2 to the head portion 1.

An area of a joint between the transition portion 3 and the head portion 1 of the screw is greater than an area of a joint between the transition portion 3 and the shaft portion 2. The axial projection of the joint between the transition portion 3 and the head portion 1 of the screw and the axial projection of the joint between the transition portion 3 and the shaft portion 2 are concentric circles. A circumferential radius of the joint between the transition portion 3 and the head portion 1 of the screw is greater than a circumferential radius of the joint between the transition portion 3 and the shaft portion 2 of the screw. The circumferential radius of the joint between the transition portion 3 and the head portion 1 of the screw is 0.1-0.2 mm greater than the circumferential radius of the joint between the transition portion 3 and the shaft portion 2 of the screw.

The shaft portion is provided with threads, and the screw is engaged with a workpiece through the threads. The axial projection of a joint between the transition portion and the head portion of the screw and the axial projection of the shaft portion of the screw are concentric circles. An axial projection area of the joint between the transition portion and the head portion of the screw is not greater than an axial projection area of the threads of the shaft portion of the screw. An axial length of the transition portion is greater than an axial length of at least two threads of the threaded shaft portion, and is less than an axial length of at most six threads of the threaded shaft portion.

In this embodiment, the axial projection area of the joint between the transition portion 3 and the head portion 1 of the screw is less than the axial projection area of the threads of the shaft portion 2 of the screw. When the screw is completely tightened, the transition surface mainly acts on an internal thread portion of the workpiece to ensure that the transition portion 3 of the screw tightly presses the workpiece while preventing the main body of the workpiece from deforming.

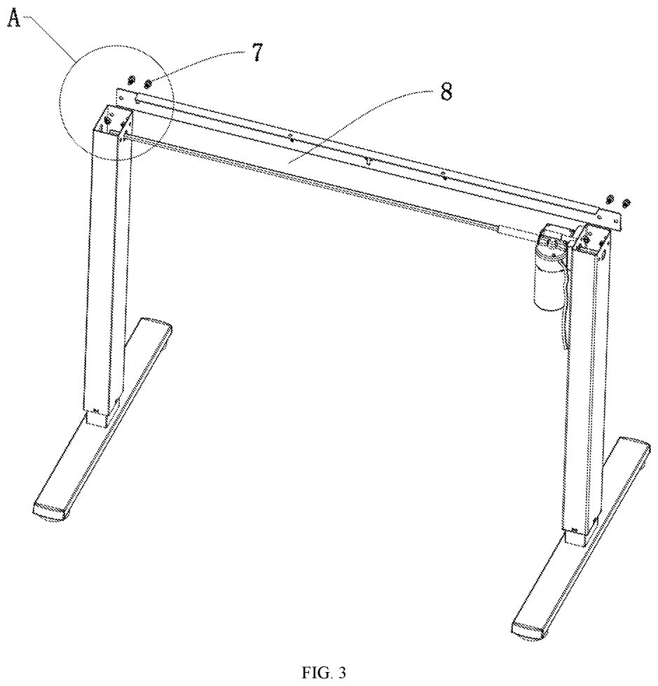

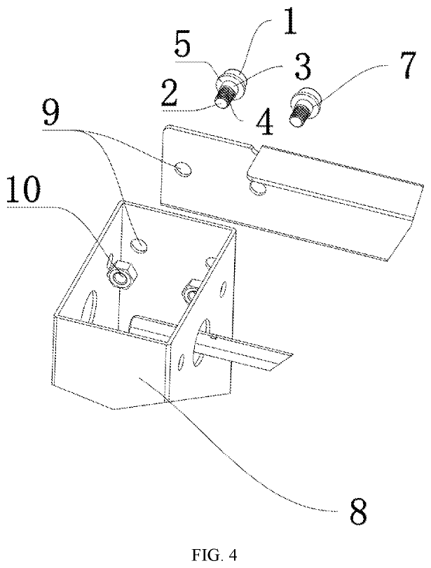

Further, the present invention may provide another embodiment, as shown in FIGS. 3 and 4.

As shown in FIGS. 3 and 4, in a main concept of this embodiment, a height-adjustable table 8 is provided. The height-adjustable table 8 uses a fastening screw in any one of the above-mentioned embodiments.

The height-adjustable table 8 is provided with a mounting hole 9 for assembly. The fastening screw passes through a corresponding mounting hole 9 to cooperate with a nut 10 through the threads 4 to connect components of the height-adjustable table 8.

In the prior art, the screw used by a height-adjustable table 8 is an ordinary screw, which is easy to fall off after long-term use. In view of this, the present invention provides a height-adjustable table 8 using the same provided by the present invention. The fastening screw has a simple structure and is not easy to loosen, which greatly prolongs the service life of the height-adjustable table 8 and improves the stability performance thereof.

The present invention provides a fastening screw and a height-adjustable table 8 using the same. The transition portion 3 is provided between the threaded section and the head portion 1 of the screw, and the transition portion 3 is threadless, which increases the contact area between the screw and the workpiece, and cooperates with the shaft portion 2 to further fasten the workpiece. The wall surface of the transition portion 3 is a tapered surface, and the transition portion 3 expands from a threaded section to the head portion 1 of the screw. In this way, the screw offers a tension expanding outward in a circumferential direction of a mounting portion, thereby improving the tightness. The joint area between the transition portion 3 and the head portion 1 does not exceed a circumferential area of threads 4. In a direction of a central axis of the screw, projection of the transition portion 3 overlaps that of the shaft portion 2, so as to prevent the transition portion 3 from falling off the workpiece or causing damage to the workpiece. The fastening screw provided by the present invention has the advantages of simple structure, desirable fastening and anti-falling performance and convenient mounting, etc.

The present invention is described in detail above. Specific cases are used herein to illustrate the principle and implementation of the present invention, and the description of the above embodiments is only intended to help understand the core idea of the present invention. It should be noted that improvements and modifications may be made by those of ordinary skill in the art without departing from the principle of the present invention, and these improvements and modifications should also fall within the protection scope of the present invention.

What is claimed is:

1. A fastening screw, comprising a head portion and a shaft portion; wherein the head portion is connected to the shaft portion;
a transition portion is provided between the head portion and the shaft portion, and the transition portion is tightly fit with a workpiece to be fastened; and
the transition portion is threadless.

2. The fastening screw according to claim 1, wherein the transition portion is provided with a tapered wall surface; the transition portion expands from the shaft portion to the head portion; and an area of a joint between the transition portion and the head portion of the fastening screw is greater than an area of a joint between the transition portion and the shaft portion.

3. The fastening screw according to claim 2, wherein an axial projection of the joint between the transition portion and the head portion of the fastening screw and an axial projection of the joint between the transition portion and the shaft portion are concentric circles.

4. The fastening screw according to claim 3, wherein a circumferential radius of the joint between the transition portion and the head portion of the fastening screw is greater than a circumferential radius of the joint between the transition portion and the shaft portion of the fastening screw.

5. The fastening screw according to claim 4, wherein the circumferential radius of the joint between the transition portion and the head portion of the fastening screw is 0.1-0.2 mm greater than the circumferential radius of the joint between the transition portion and the shaft portion of the fastening screw.

6. The fastening screw according to claim 1, wherein an axial projection of a joint between the transition portion and the head portion of the fastening screw and an axial projection of the shaft portion of the fastening screw are concentric circles.

7. The fastening screw according to claim 6, wherein an axial projection area of the joint between the transition portion and the head portion of the fastening screw is less than or equal to an axial projection area of threads of the shaft portion of the fastening screw.

8. The fastening screw according to claim 1, wherein an axial length of the transition portion is greater than an axial length of two threads of the threaded shaft portion, and is less than an axial length of six threads of the threaded shaft portion.

9. A height-adjustable table, wherein the height-adjustable table uses the fastening screw according to claim 1.

10. The height-adjustable table according to claim 9, wherein the height-adjustable table is provided with a mounting hole for assembly; and the fastening screw passes through the mounting hole to cooperate with a nut through threads to connect components of the height-adjustable table.

11. The height-adjustable table according to claim 9, wherein the transition portion is provided with a tapered wall surface; the transition portion expands from the shaft portion to the head portion; and an area of a joint between the transition portion and the head portion of the fastening screw is greater than an area of a joint between the transition portion and the shaft portion.

12. The height-adjustable table according to claim 11, wherein an axial projection of the joint between the transition portion and the head portion of the fastening screw and an axial projection of the joint between the transition portion and the shaft portion are concentric circles.

13. The height-adjustable table according to claim 12, wherein a circumferential radius of the joint between the transition portion and the head portion of the fastening screw is greater than a circumferential radius of the joint between the transition portion and the shaft portion of the fastening screw.

14. The height-adjustable table according to claim 13, wherein the circumferential radius of the joint between the transition portion and the head portion of the fastening screw is 0.1-0.2 mm greater than the circumferential radius of the joint between the transition portion and the shaft portion of the fastening screw.

15. The height-adjustable table according to claim 9, wherein an axial projection of a joint between the transition portion and the head portion of the fastening screw and an axial projection of the shaft portion of the fastening screw are concentric circles.

16. The height-adjustable table according to claim 15, wherein an axial projection area of the joint between the transition portion and the head portion of the fastening screw is less than or equal to an axial projection area of threads of the shaft portion of the fastening screw.

17. The height-adjustable table according to claim 9, wherein an axial length of the transition portion is greater than an axial length of two threads of the threaded shaft portion, and is less than an axial length of six threads of the threaded shaft portion.
